(19) United States
(12) Patent Application Publication
(10) Pub. No.: US 2025/0231810 A1
(43) Pub. Date: Jul. 17, 2025

(54) Apparatus for Controlling Vehicle and Method Thereof

(71) Applicants: Hyundai Motor Company, Seoul (KR); Kia Corporation, Seoul (KR); HYUNDAI AUTOEVER Corp., Seoul (KR)

(72) Inventors: Yu Ho Choi, Seoul (KR); Kyung Taek Kim, Anyang-si (KR)

(21) Appl. No.: 18/755,833

(22) Filed: Jun. 27, 2024

(30) Foreign Application Priority Data
Jan. 17, 2024 (KR) 10-2024-0007495

(51) Int. Cl. G06F 9/50; B60W 50/00; B60W 60/00

(52) U.S. Cl. CPC G06F 9/5038; B60W 60/001; B60W 2050/0005; G06F 2212/173

(57) ABSTRACT

An apparatus for controlling autonomous driving of a vehicle is introduced. The apparatus may generate profiling data comprising an access count of each of a plurality of sections, wherein the plurality of sections are associated with at least one task performed for an operation control of the vehicle. The apparatus may determine, based on the profiling data, a priority for each of the plurality of sections. Further, the apparatus may assign, based on the priority, the plurality of sections to one or more of a plurality of storage devices included in the memory, output, based on the sequentially assigned plurality of sections, a signal for the operation control of the vehicle, and control, based on the signal, an operation of autonomous driving of the vehicle.

### CROSS-REFERENCE TO RELATED APPLICATION

This application claims the benefit of priority to Korean Patent Application No. 10-2024-0007495, filed in the Korean Intellectual Property Office on Jan. 17, 2024, the entire contents of which are incorporated herein by reference.

### TECHNICAL FIELD

The present disclosure relates to a vehicle control apparatus and a method thereof, and more particularly, relate to a technology for efficiently assigning sections included in a task to a storage device.

### BACKGROUND

Unlike CPUs or APs using a dynamic random access memory (DRAM), most micro controller unit (MCU) System on Chips (SoCs) may be implemented based on an on-chip static random access memory (SRAM). Accordingly, the performance of an MCU may be improved depending an on algorithm used, based on characteristics of an SRAM different from the DRAM, for MCU utilization and/or memory map configuration.

For example, overall issues such as task execution time, power consumption of an MCU, and heat issues may be solved depending on criteria for assigning sections included in the task to a storage device in a process of implementing a memory map of an MCU program.

In the meantime, a method in which a compiler analyzes a multi-core program and assigning each section (e.g., block started by symbol (BSS), data, or text) to the storage device may be used for memory mapping. However, because the compiler generally focuses on characteristics of programs generally used, characteristics of various types of programs may not be reflected.

Furthermore, a method in which a developer directly analyzes operating characteristics of a program and prepares a memory map in consideration of a memory access time and memory size in a heuristic manner may be used for memory mapping However, because this method may rely on direct intervention by the developer, it may be somewhat less efficient in terms of cost and time.

### SUMMARY

According to the present disclosure, an apparatus for controlling a vehicle, the apparatus comprising a memory configured to store at least one instruction, and a control device operatively connected to the memory, wherein the at least one instruction, when executed by the control device, cause the apparatus to, generate profiling data comprising an access count of each of a plurality of sections, wherein the plurality of sections are associated with at least one task performed for an operation control of the vehicle, determine based on the profiling data, a priority for each of the plurality of sections, sequentially assign based on the priority, the plurality of sections or more of a plurality of storage devices included in the memory, output based on the sequentially assigned plurality of sections, a signal for the operation control of the vehicle, and control, based on the signal, an operation of autonomous driving of the vehicle.

The apparatus, wherein the at least one instruction, when executed by the control device, cause the apparatus to determine based on a level of the access count, the priority for each of the plurality of sections.

The apparatus, wherein the at least one instruction, when executed by the control device, cause the apparatus to generate based on the profiling data, a table comprising the priority, and determine based on the table, a section for traversal among the plurality of sections.

The apparatus, wherein the at least one instruction, when executed by the control device, cause the apparatus to determine based on a first size of a first section of the plurality of sections, a first minimum cost device among the plurality of storage devices for the first section, wherein the first size corresponds to a first rank among the plurality of sections, and assign the first section to the first minimum cost device.

The apparatus, wherein the at least one instruction, when executed by the control device, cause the apparatus to determine a first group of storage devices of the plurality of storage devices, wherein each storage device of the first group has a storage capacity that is greater than the first size, and determine a storage device of the first group of storage devices, as the first minimum cost device, wherein an access cycle of the storage device is smallest among the first group of storage devices.

The apparatus, wherein the at least one instruction, when executed by the control device, cause the apparatus to determine based on a second size of a second section of the plurality of sections, a second minimum cost device among the plurality of storage devices for the second section, wherein the second size corresponds to a second rank among the plurality of sections, compare based on a value associated with the second minimum cost device being the same as a value associated with the first minimum cost device, a sum of the first size and the second size with a first storage capacity of the first minimum cost device, and assign based on the sum being smaller than the first storage capacity, the second section to the first minimum cost device.

The apparatus, wherein the at least one instruction, when executed by the control device, cause the apparatus to determine based on a second size of a second section of the plurality of sections, a second minimum cost device for the second section, wherein the second size corresponds to a second rank among the plurality of sections, compare based on a value associated with the second minimum cost device being the same as a value associated with the first minimum cost device, a sum of the first size and the second size with a first storage capacity of the first minimum cost device, and exclude based on a value associated with the second minimum cost device being greater as a value associated with the first minimum cost device, the first minimum cost device from the plurality of storage devices and assign the second section to the second minimum cost device.

The apparatus may further comprise a communication device, wherein the at least one instruction, when executed by the control device, cause the apparatus to, receive based on the communication device and from an outside of the apparatus, additional profiling data regarding the plurality of sections, and determine based on the additional profiling data, a priority for each of the plurality of sections.

According to the present disclosure, a method for controlling a vehicle, the method may comprise generating by a control device, profiling data comprising an access count of each of a plurality of sections, wherein the plurality of sections are associated with at least one task performed for an operation control of the vehicle, determining based on the profiling data, a priority for each of the plurality of sections, sequentially assigning based on the priority, the plurality of sections to one or more of a plurality of storage devices included in a memory, outputting based on the sequentially assigned plurality of sections, a signal for the operation control of the vehicle, and controlling, based on the signal, an operation of autonomous driving of the vehicle.

The method may further comprise determining based on a level of the access count, the priority for each of the plurality of sections.

The method may further comprise generating based on the profiling data, a table comprising the priority, and determining based on the table, a section for traversal among the plurality of sections.

The method may further comprise determining based on a first size of a first section of the plurality of sections, a first minimum cost device among the plurality of storage devices for the first section, wherein the first size corresponds to a first rank among the plurality of sections, and assigning the first section to the first minimum cost device.

The method may further comprise determining a first group of storage devices of the plurality of storage devices, wherein each storage device of the first group has a storage capacity that is greater than the first size, and determining a storage device of the first group of storage devices, as the first minimum cost device, wherein an access cycle of the storage device is smallest among the first group of storage devices.

The method may further comprise determining based on a second size of a second section of the plurality of sections, a second minimum cost device among the plurality of storage devices for the second section, wherein the second size corresponds to a second rank among the plurality of sections, comparing based on a value associated with the second minimum cost device being the same as a value associated with the first minimum cost device, a sum of the first size and the second size with a first storage capacity of the first minimum cost device, and assigning based on the sum being smaller than the first storage capacity, the second section to the first minimum cost device.

The method may further comprise determining based on a second size of a second section of the plurality of sections, a second minimum cost device for the second section, wherein the second size corresponds to a second rank among the plurality of sections, and comparing based on a value associated with the second minimum cost device being the same as a value associated with the first minimum cost device, a sum of the first size and the second size with a first storage capacity of the first minimum cost device or excluding, based on a value associated with the second minimum cost device being greater as a value associated with the first minimum cost device, the first minimum cost device from the plurality of storage devices and assigning the second section to the second minimum cost device.

A non-transitory computer-readable recording medium including a program for executing a method, the method comprising generating by a control device, profiling data comprising an access count of each of a plurality of sections, wherein the plurality of sections are associated at least one task performed for an operation control of a vehicle, determining based on the profiling data, a priority for each of the plurality of sections, sequentially assigning based on the priority, the plurality of sections to one or more of a plurality of storage devices included in a memory, and outputting based on the sequentially assigned plurality of sections, a signal for the operation control of the vehicle.

The non-transitory computer-readable recording medium, wherein the method may further comprise determining based on a level of the access count, the priority for each of the plurality of sections.

The non-transitory computer-readable recording medium, wherein the method may further comprise generating based on the profiling data, a table comprising the priority, and determining based on the table, a section for traversal among the plurality of sections.

The non-transitory computer-readable recording medium, wherein the method may further comprise determining based on a first size of a first section of the plurality of sections, a first minimum cost device among the plurality of storage devices for the first section, wherein the first size corresponds to a first rank among the plurality of sections, and assigning the first section to the first minimum cost device.

The non-transitory computer-readable recording medium, wherein the method may further comprise determining a first group of storage devices of the plurality of storage devices, wherein each storage device of the first group has a storage capacity that is greater than the first size, and determining a storage device, of the first group of storage devices, as the first minimum cost device, wherein an access cycle of the storage device is smallest among the first group of storage devices.

### BRIEF DESCRIPTION OF THE DRAWINGS

The above and other objects, features and advantages of the present disclosure will be more apparent from the following detailed description taken in conjunction with the accompanying drawings:

FIG. 1 shows an example of components of a vehicle control apparatus, according to an example of the present disclosure;

FIG. 2 shows an example of components and operations of a vehicle control apparatus, according to an example of the present disclosure;

FIG. 3 shows an example of a flowchart of a vehicle control method, according to an example of the present disclosure;

FIG. 4A shows an example of a table showing information about sections and storage devices, according to an example of the present disclosure;

FIG. 4B shows an example of an order in which a vehicle control apparatus assigns a section to a storage device, according to an example of the present disclosure;

FIG. 5 shows an example of a flowchart of a vehicle control method, according to an example of the present disclosure; and

FIG. 6 shows an example of a computing system related to a vehicle control apparatus or vehicle control method, according to an example of the present disclosure.

With regard to description of drawings, the same or similar components will be marked by the same or similar reference signs.

### DETAILED DESCRIPTION

Hereinafter, some examples of the present disclosure will be described in detail with reference to the accompanying drawings. In adding reference numerals to components of each drawing, it should be noted that the same components include the same reference numerals, although they are indicated on another drawing. Furthermore, in describing the examples of the present disclosure, detailed descriptions associated with well-known functions or configurations will be omitted if they may make subject matters of the present disclosure unnecessarily obscure.

In describing elements of an example of the present disclosure, the terms first, second, A, B, (a), (b), and the like may be used herein. These terms are only used to distinguish one element from another element, but do not limit the corresponding elements irrespective of the nature, order, or priority of the corresponding elements. Furthermore, unless otherwise defined, all terms including technical and scientific terms used herein are to be interpreted as is customary in the art to which the present disclosure belongs. It will be understood that terms used herein should be interpreted as including a meaning that is consistent with their meaning in the context of the present disclosure and the relevant art and will not be interpreted in an idealized or overly formal sense unless expressly so defined herein.

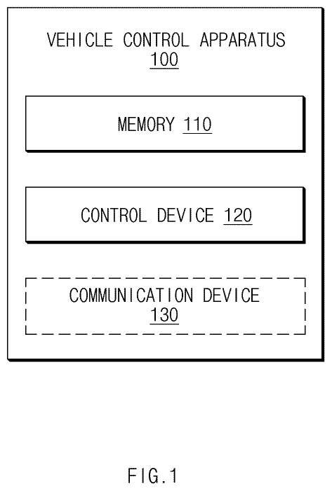

Hereinafter, various examples of the present disclosure will be described in detail with reference to FIGS. 1 to 6.

FIG. 1 shows an example of components of a vehicle control apparatus, according to an example of the present disclosure.

According to an example, a vehicle control apparatus 100 may include a memory 110, a control device 120, and/or a communication device 130. The configuration of the vehicle control apparatus 100 shown in FIG. 1 is an example, and examples of the present disclosure are not limited thereto. For example, the vehicle control apparatus 100 may further include components not shown in FIG. 1 (e.g., at least one of a sensor device, an interface device, a display device, or a notification device, or any combination thereof).

According to an example, the memory 110 may store instructions or data. For example, the memory 110 may store one or more instructions that cause the vehicle control apparatus 100 to perform various operations if executed by the control device 120.

For example, the memory 110 and the control device 120 may be implemented as one chipset. The control device 120 may include at least one of a communication processor or a modem.

For example, the memory 110 may store various pieces of information related to the vehicle control apparatus 100. For example, the memory 110 may store information about the operating history of the control device 120. For example, the memory 110 may store information related to states and/or operations of components (e.g., at least one of an engine control unit (ECU), MCU, a plurality of storage devices, the memory 110, or the control device 120, or any combination thereof) of a host vehicle.

For example, the memory 110 may include different types of storage devices. For example, the memory 110 may include at least one of a random-access memory (RAM), or an embedded multi-media card (eMMC), or any combination thereof.

For example, the memory 110 may include a plurality of storage devices including at least one of a data scratch pad RAM (DSPR), a data local memory unit (DLMU), a local memory unit (LMU), or a default application memory (DAM), or any combination thereof.

According to an example, the control device 120 may be operatively connected to the memory 110 and/or the communication device 130. For example, the control device 120 may control the operation of the memory 110 and/or the communication device 130.

For example, the control device 120 may generate profiling data including an access count of each of a plurality of sections included in at least one task (e.g., acceleration, deceleration, steering control, gear shifting control, braking system control, traction control, stability control, cruise control, lane keeping assist control, collision avoidance system control, emergency brake assistance control, traffic sign recognition control, adaptive headlight control, etc.).

For example, the task may be defined as an execution unit of a program executed by the control device 120.

For example, the section may be defined as a structural unit (e.g., a minimum or smallest structural unit), which is included in the task and/or which is stored in a storage device.

For example, the profiling data may include information about each of the sections. For example, the profiling data may include the size and access count of each of the sections. For example, the access count may be the number or quantity of times that a section to which a task is assigned is accessed, based on the section being assigned to a storage device.

For example, the control device 120 may further receive additional profiling data from an external source (e.g., an external library). The control device 120 may merge the additional profiling data received from the external source and the generated profiling data, and then may perform subsequent operations.

For example, the control device 120 may determine a priority for each of the plurality of sections based on the profiling data.

For example, the control device 120 may determine the priority for each of the plurality of sections based on a level of the access count (e.g., a quantity of the access count). For example, the control device 120 may assign a high priority to a section with a great access count based on the profiling data.

In other words, the control device 120 may sort the plurality of sections in descending order based on the level of the access count, and may assign a higher priority to the plurality of sections as the access count increases.

For example, the control device 120 may create a table (or graph) based on the profiling data, and may determine one section among the plurality of sections based on the table. For example, the control device 120 may create the table including the access count of each of the plurality of sections, and may determine a section for traversal based on the table. For example, the control device 120 may identify a storage device to which the determined section is to be assigned.

For example, the control device 120 may sequentially assign the plurality of sections to some of a plurality of storage devices included in the memory 110 based on the priority.

For example, the control device 120 may determine a storage device, to which a first section corresponding to the first rank, from among the plurality of sections is to be assigned. For example, the first section may be a section with the greatest access count among the plurality of sections for which the storage device to be assigned is not determined.

For example, the control device 120 may identify (or determine) a first minimum cost device for the first section among the plurality of storage devices based on the first size of the first section, and a storage capacity and an access cycle of each of the plurality of storage devices. The control device 120, for example, may assign the first section to the first minimum cost device.

For example, the control device 120 may identify a first group of storage devices, of each of which a storage capacity is greater than the first size of the first section, from among the plurality of storage devices. In other words, the control device 120 may identify the first group of storage devices, of each of which the storage capacity is greater than the first size of the first section, as a candidate group for assigning the first section.

For example, the control device 120 may identify the storage device with the smallest access cycle, which is expected if the first section is assigned, from among the first group of storage devices as the first minimum cost device. In other words, if the first section is assigned, the access cycle (e.g., an operating period required or applied to access the corresponding storage device) of the corresponding storage device among storage devices with a storage capacity, to which the first section is capable of being assigned, is relatively small. Accordingly, the control device 120 may identify the most efficiently mappable storage device as the first minimum cost device.

For example, after the first section corresponding to the first rank is completely assigned, the control device 120 may determine the storage device to which the second section corresponding to a second rank is to be assigned.

For example, the control device 120 may identify (or determine) the second minimum cost device for the second section based on a second size of the second section, and a storage capacity and an access cycle of each of the plurality of storage devices.

For example, if the second minimum cost device is the same as the first minimum cost device to which the first section is assigned, the control device 120 may compare the sum of the first size and second size with the first storage capacity of the first minimum cost device.

For example, if the comparison result indicates the sum of the first size and the second size is smaller than the first storage capacity, the control device 120 may assign the second section to the first minimum cost device. In other words, in this case, the control device 120 may assign both the first section and the second section to the first minimum cost device.

For example, if the comparison result indicates the sum of the first size and the second size is greater than first storage capacity, the control device 120 may identify another storage device other than the first minimum cost device. For example, if the second section, other than the first minimum cost device, from among the plurality of storage devices is assigned, the control device 120 may assign the second section to the second minimum cost device with the smallest access cycle. In this case, the storage capacity of the second minimum cost device may be greater than the size of the second section.

According to an example, the communication device 130 may establish a communication channel (e.g., a wireless communication channel, Wi-Fi, Bluetooth, NFC, Zigbee, Cellular network, Satellite communication channel, optical communication channel, power line communication, etc.) between the vehicle control apparatus 100 and an external device (e.g., an external library) and may support communication through the established communication channel. For example, the communication device 130 may include one or more communication processors which are operated independently of the control device 120 and support direct (or wired) communication or wireless communication.

For example, the communication device 130 may include a wireless communication module (e.g., a cellular communication module, a short-range wireless communication module, or a global navigation satellite system (GNSS) communication module) or a wired communication module (e.g., a local area network (LAN) communication module or a power line communication module). The corresponding communication module among these communication modules may communicate with an external device through a first network (e.g., a short-range communication network such as Bluetooth, wireless fidelity (WiFi) direct or infrared data association (IrDA)) or a second network (e.g., long-range wireless communication network such as a legacy cellular network, 5G networks, next-generation communication networks, Internet, or computer networks (e.g., LAN or WAN)) included in a network. The above-described kinds of communication modules may be integrated in one component (e.g., a single chip) or may be implemented with a plurality of components (e.g., a plurality of chips) which are independent of each other. Also, the communication device 130 and the control device 120 may be implemented as a single chip.

For example, the communication device 130 may transmit or receive various data based on communication with an external device.

For example, the communication device 130 may receive additional profiling data regarding the plurality of sections from the external device.

The numerical limitations according to the above-described examples are illustrative, and examples of the present disclosure are not limited thereto. For example, the numerical limitations for driving speed, acceleration, required or applied acceleration, and braking pressure are illustrative and may be changed by a developer and/or a user's settings.

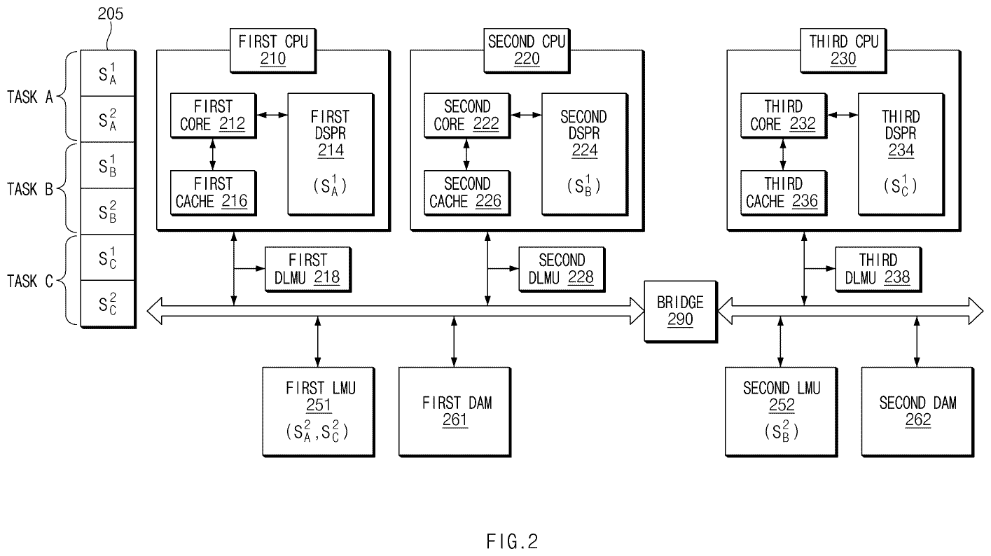

FIG. 2 shows an example of components and operations of a vehicle control apparatus, according to an example of the present disclosure.

According to an example, a vehicle control apparatus (e.g., the vehicle control apparatus 100 of FIG. 1) may include at least one of a first CPU 210, a second CPU 220, or a third CPU 230, or any combination thereof.

For example, the first CPU 210 may include a first core 212, a first cache 216, and a first DSPR 214.

For example, the second CPU 220 may include a second core 222, a second cache 226, and a second DSPR 224.

For example, the third CPU 230 may include a third core 232, a third cache 236, and a third DSPR 234.

For example, the vehicle control apparatus may include a plurality of storage devices including at least one of the first DSPR 214, the second DSPR 224, the third DSPR 234, a first DLMU 218, a second DLMU 228, a third DLMU 238, a first LMU 251, a second LMU 252, a first DAM 261, or a second DAM 262, or any combination thereof.

For example, the first DLMU 218 may be electrically connected to the first CPU 210.

For example, the second DLMU 228 may be electrically connected to the second CPU 220.

For example, the third DLMU 238 may be electrically connected to the third CPU 230.

For example, the first LMU 251 and the first DAM 261 may be electrically connected to the first CPU 210 and/or the second CPU 220 through a first bus.

For example, the first LMU 251 and the second DAM 262 may be electrically connected to the third CPU 230 through a second bus.

For example, the first bus and the second bus may be electrically connected to each other through a bridge 290.

For example, the vehicle control apparatus may assign a plurality of sections included in a plurality of tasks to at least part of the plurality of storage devices.

For example, the vehicle control apparatus may identify an access count of each of A-1 section S_{A}¹ and A-2 section S_{A}² included in task A, B-1 section S_{B}¹ and B-2 section S_{B}² included in task B, and C-1 section S_{C}¹ and C-2 section S_{C}² included in task C, and may sequentially determine a storage device, to which a section is to be assigned, starting from the section with the greatest access count.

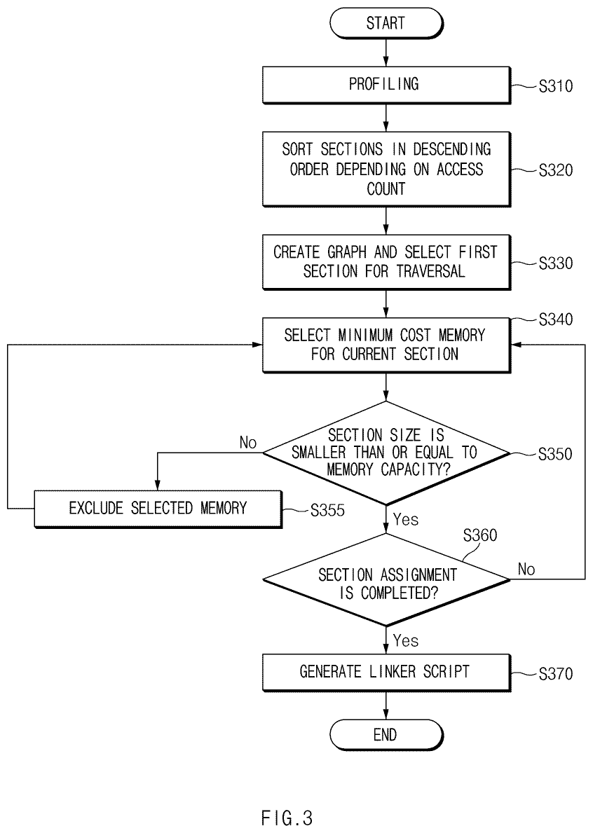

FIG. 3 shows an example of a flowchart of a vehicle control method, according to an example of the present disclosure.

According to an example, a vehicle control apparatus (e.g., the vehicle control apparatus 100 of FIG. 1) may perform operations described in FIG. 3. For example, at least some of components (e.g., the memory 110, the control device 120, and/or the communication device 130 in FIG. 1) included in the vehicle control apparatus may be configured to perform operations of FIG. 3.

In the following example, operations in S310 to S370 may be sequentially or non-sequentially performed. For example, the order of operations may be changed, and at least two operations may be performed in parallel. Moreover, descriptions corresponding to or identical to the above-mentioned descriptions given with reference to FIG. 3 may be briefly described or omitted to avoid redundancy.

According to an example, the vehicle control apparatus may perform a profiling operation (S310).

For example, to identify at least one of the access count, or size, or any combination thereof for each of a plurality of sections included in a plurality of tasks, the vehicle control apparatus may generate, based on performing a profiling operation for each of the plurality of sections, profiling data.

According to an example, the vehicle control apparatus may sort sections in descending order depending on an access count (S320).

For example, the vehicle control apparatus may sort the plurality of sections based on the profiling data in descending order starting from the section with the greatest access count.

According to an example, the vehicle control apparatus may create a graph and may select a first section for traversal (S330).

For example, the vehicle control apparatus may create a graph (or table) based on the sorted result in S320. For example, the graph may include information about at least one of the size of each of the plurality of sections, the access count of each of the plurality of sections, or the access cycle expected if the plurality of sections are assigned to one or more of a plurality of storage devices, or any combination thereof.

For example, the vehicle control apparatus may select the first section. For example, the vehicle control apparatus may select the first section for traversal based on a level of the access count. In other words, the vehicle control apparatus may select the first section with the greatest access count as the first section for traversal.

According to an example, the vehicle control apparatus may select the minimum cost memory for a current section (S340).

For example, the vehicle control apparatus may identify the first section selected in S330 as the current section and may select (or determine) the minimum cost memory for the first section.

For example, control apparatus may the vehicle determine the storage device with the smallest access cycle, which is expected if the first section is assigned, as the first minimum cost memory for the first section.

According to an example, the vehicle control apparatus may determine whether the section size is smaller than or equal to a memory capacity (S350).

For example, the vehicle control apparatus may determine whether the size of the first section is smaller than or equal to the storage capacity of the first minimum cost memory.

For example, if the section size is smaller than or equal to the memory capacity (e.g., S350—Yes), the vehicle control apparatus may perform S360.

For example, if the section size exceeds the memory capacity (e.g., S350—No), the vehicle control apparatus may perform S355.

According to an example, the vehicle control apparatus may exclude the selected memory (S355).

For example, the vehicle control apparatus may exclude the first minimum cost memory, and then may select the minimum cost memory for the first section again according to S340.

For example, the vehicle control apparatus may determine the storage device with the smallest access cycle, which is expected if the first section is assigned, from among a plurality of storage devices excluding the first minimum cost memory as the minimum cost device for the first section.

According to an example, the vehicle control apparatus may determine whether section assignment is completed (S360).

For example, the vehicle control apparatus may determine whether all minimum cost devices corresponding to a plurality of sections are determined.

For example, if the section assignment is completed (e.g., S360—Yes), the vehicle control apparatus may perform S370.

For example, if the section assignment is not completed (e.g., S360—No), the vehicle control apparatus may repeat S340. In other words, the vehicle control apparatus may perform S340 based on identifying a section, to which the minimum cost device is not assigned, as the current section.

According to an example, the vehicle control apparatus may generate a linker script (S370). For example, a linker script may be a configuration file used by a linker to specify memory layout and organization of software components in a final executable or binary file. A linker script may define memory layout of executable files (e.g., location of code, data, other resources within a memory space).

For example, the vehicle control apparatus may generate the linker script based on section assignment information completed according to S360.

For example, the vehicle control apparatus may create, based on a linker, a memory map based on the linker script.

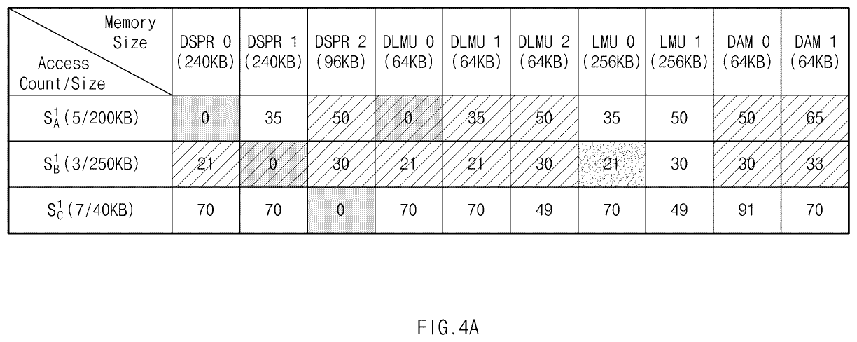

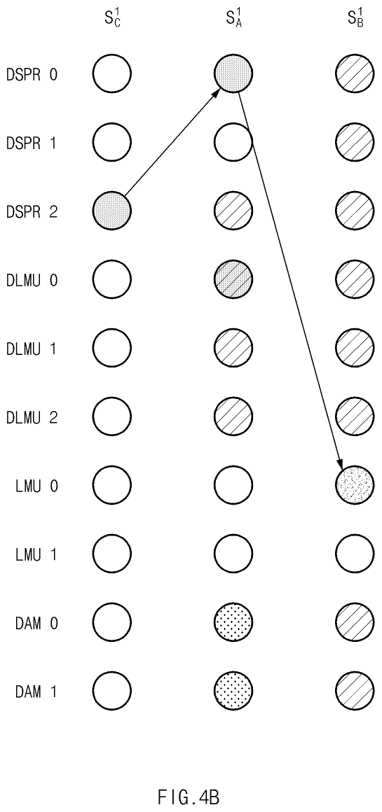

FIG. 4A shows an example of a table showing information about sections and storage devices, according to an example of the present disclosure.

FIG. 4B shows an example of an order in which a vehicle control apparatus assigns a section to a storage device, according to an example of the present disclosure.

Referring to FIG. 4A, according to an example, a vehicle control apparatus (e.g., the vehicle control apparatus 100 of FIG. 1) may create a table regarding A-1 section S_{A}¹, B-1 section S_{B}¹, and C-1 section S_{C}¹.

For example, the vehicle control apparatus may generate profiling data for A-1 section S_{A}¹, B-1 section S_{B}¹, and C-1 section S_{C}¹, and may generate the table according to FIG. 4A based on the profiling data.

Referring to FIG. 4A, for example, the vehicle control apparatus may identify that access counts of A-1 section S_{A}¹, B-1 section S_{B}¹, and C-1 section S_{C}¹ are 5, 3, and 7, respectively. Accordingly, the vehicle control apparatus may determine the priority for A-1 section S_{A}¹ as a second rank, may determine the priority for B-1 section S_{B}¹ as a third rank, and may determine the priority for C-1 section Sol as a first rank.

For example, the vehicle control apparatus may determine the minimum cost device to which C-1 section S_{C}¹ corresponding to the first rank is to be assigned.

For example, the vehicle control apparatus may determine DSPR 2 with the smallest access cycle (e.g., 0) expected if C-1 section S_{C}¹ is assigned, from among a plurality of storage devices as the minimum cost device to which C-1 section S_{C}¹ is to be assigned. Because the storage capacity (e.g., 96 KB) of DSPR 2 is greater than the size of C-1 section S_{C}¹ (e.g., 40 KB), the vehicle control apparatus may determine DSPR 2 as the minimum cost device to which C-1 section S_{C}¹ is to be assigned.

For example, after C-1 section S_{C}¹ is completely assigned, the vehicle control apparatus may determine the minimum cost device to which A-1 section S_{A}¹ corresponding to the second rank is assigned.

For example, the vehicle control apparatus may first identify DSPR 0 and DLMU 0 with the smallest access cycle (e.g., 0), which are expected if A-1 section S_{A}¹ is assigned, from among the plurality of storage devices as a first group of storage devices. Because the storage capacity of DLMU 0 (e.g., 64 KB) is smaller than the size of A-1 section S_{A}¹ (e.g., 200 KB), the vehicle control apparatus may determine DSPR 0, which is the remaining storage device, as the minimum cost device to which A-1 section S_{A}¹ is to be assigned.

For example, after C-1 section S_{C}¹ and A-1 section S_{A}¹ are completely assigned, the vehicle control apparatus may determine the minimum cost device to which B-1 section S_{B}¹ corresponding to the third rank is assigned.

For example, the vehicle control apparatus may first identify DSPR 1 with the smallest access cycle (e.g., 0), which is expected if B-1 section S_{B}¹ is assigned, from among the plurality of storage devices. Because the storage capacity (e.g., 240 KB) of DSPR 1 is smaller than the size (e.g., 250 KB) of B-1 section S_{B}¹, the vehicle control apparatus may exclude DSPR 1 from assignment candidates of B-1 section S_{B}¹. Afterward, the vehicle control apparatus may identify a second group of storage devices with the smallest access cycle (e.g., 21), which are expected if B-1 section S_{B}¹ is assigned, from among the plurality of storage devices other than DSPR 1. The second group of storage devices may include DSPR 0, DLMU 0, DLMU 1, and LMU 0. For example, the vehicle control apparatus may determine LMU 0, whose storage capacity is greater than the size of B-1 section S_{B}¹, among the second group of storage devices as the minimum cost device to which B-1 section S_{B}¹ is to be assigned.

The storage device assignment algorithm described above is illustrative, and examples of the present disclosure are not limited thereto. For example, the vehicle control apparatus may first identify a storage device whose storage capacity is greater than the size of a section. Afterward, the vehicle control apparatus may perform a storage device assignment algorithm in a method of determining the storage device with the smallest access cycle expected if a section is assigned to the corresponding storage device.

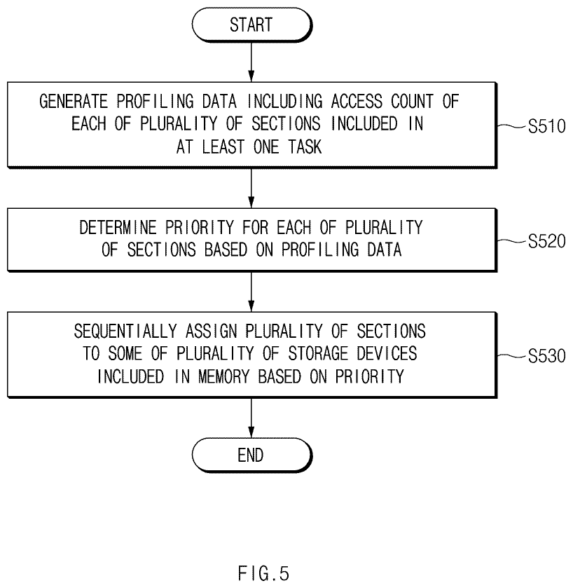

FIG. 5 shows an example of a flowchart of a vehicle control method, according to an example of the present disclosure.

According to an example, a vehicle control apparatus (e.g., the vehicle control apparatus 100 of FIG. 1) may perform operations described in FIG. 5. For example, at least some of components (e.g., the memory 110, the control device 120, and/or the communication device 130 in FIG. 1) included in the vehicle control apparatus may be configured to perform operations of FIG. 5.

In the following example, S510 to S530 may be sequentially or non-sequentially performed. For example, the order of operations may be changed, and at least two operations may be performed in parallel. Moreover, descriptions corresponding to or identical to the above-mentioned descriptions given with reference to FIG. 5 may be briefly described or omitted to avoid redundancy.

According to an example, the vehicle control apparatus may generate profiling data including an access count of each of a plurality of sections included in at least one task (S510).

According to an example, the vehicle control apparatus may determine a priority for each of the plurality of sections based on the profiling data (S520).

According to an example, the vehicle control apparatus may sequentially or non-sequentially assign the plurality of sections to some of a plurality of storage devices (e.g., a random-access memory (RAM), an embedded multi-media card (eMMC), a data scratch pad RAM (DSPR), a data local memory unit (DLMU), a local memory unit (LMU), or a default application memory (DAM), etc.) included in the memory based on the priority (S530).

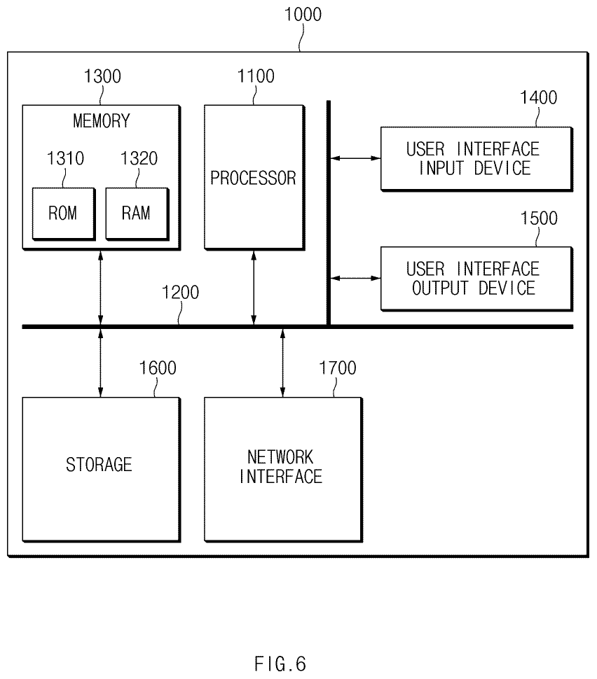

FIG. 6 shows an example of a computing system related to a vehicle control apparatus or vehicle control method, according to an example of the present disclosure.

Referring to FIG. 6, a computing system 1000 related to a vehicle control apparatus or a vehicle control method may include at least one processor 1100, a memory 1300, a user interface input device 1400, a user interface output device 1500, a storage 1600, and a network interface 1700, which are connected with each other via a bus 1200.

The processor 1100 may be a central processing unit (CPU) or a semiconductor device that processes instructions stored in the memory 1300 and/or the storage 1600. Each of the memory 1300 and the storage 1600 may include various types of volatile or nonvolatile storage media. For example, the memory 1300 may include a read only memory (ROM) 1310 and a random access memory (RAM) 1320.

Accordingly, the operations of the method or algorithm described in connection with the examples disclosed in the specification may be directly implemented with a hardware module, a software module, or a combination of the hardware module and the software module, which is executed by the processor 1100. The software module may reside on a storage medium (i.e., the memory 1300 and/or the storage 1600) such as a random access memory (RAM), a flash memory, a read only memory (ROM), an erasable and programmable ROM (EPROM), an electrically EPROM (EEPROM), a register, a hard disk drive, a removable disc, or a compact disc-ROM (CD-ROM).

The storage medium may be coupled to the processor 1100. The processor 1100 may read out information from the storage medium and may write information in the storage medium. Alternatively, the storage medium may be integrated with the processor 1100. The processor and storage medium may be implemented with an application specific integrated circuit (ASIC). The ASIC may be provided in a user terminal. Alternatively, the processor and storage medium may be implemented with separate components in the user terminal.

The present disclosure was made to solve the above-mentioned problems.

An example of the present disclosure provides a vehicle control apparatus that may generate profiling data for each of sections included in a task, may determine a priority based on profiling data including an access count, may sequentially assign sections to a storage device starting from a section with a high priority, and may perform stable and highly accurate memory mapping operations.

An example of the present disclosure provides a vehicle control apparatus that may assign a high priority to a section with a great access count, and may determine a minimum cost device, to which a section is assigned, based on the size of a section with a high priority, the storage capacity of a storage device, and an access cycle required or applied if the section is assigned.

An example of the present disclosure provides a vehicle control apparatus that may compare the sum of sizes of a plurality of sections with the storage capacity of the minimum cost device, and may determine whether to assign the plurality of sections to one minimum cost device based on the comparison result, if it is identified that the plurality of sections need to be assigned to the one minimum cost device.

An example of the present disclosure provides a vehicle control apparatus that may determine, based on further using additional profiling data received from an external source (e.g., an external library), a priority, may perform assignment operations for each of the sections, and may derive memory mapping results more adaptively and efficiently.

An example of the present disclosure provides a vehicle control apparatus that may perform a memory mapping operation with higher accuracy and more efficiency compared to a memory mapping operation performed by a compiler, and may generate universally usable results while minimizing man-hours, because a developer does not need to directly intervene.

The technical problems to be solved by the present disclosure are not limited to the aforementioned problems, and any other technical problems not mentioned herein will be clearly understood from the following description by those skilled in the art to which the present disclosure pertains.

According to an example of the present disclosure, a vehicle control apparatus may include a memory that stores at least one instruction, and a control device operatively connected to the memory. For example, if executed by the control device, the at least one instruction may cause the vehicle control apparatus to generate profiling data including an access count of each of a plurality of sections included in at least one task, to determine a priority for each of the plurality of sections based on the profiling data, and to sequentially assign the plurality of sections to some of a plurality of storage devices included in the memory based on the priority.

According to an example, if executed by the control device, the at least one instruction may cause the vehicle control apparatus to determine the priority for each of the plurality of sections based on a level of the access count.

According to an example, if executed by the control device, the at least one instruction may cause the vehicle control apparatus to create a table including the priority based on the profiling data, and to determine a section for traversal among the plurality of sections based on the table.

According to an example, if executed by the control device, the at least one instruction may cause the vehicle control apparatus to identify a first minimum cost device for a first section among the plurality of storage devices based on a first size of the first section corresponding to a first rank among the plurality of sections, and a storage capacity and an access cycle of each of the plurality of storage devices, and to assign the first section to the first minimum cost device.

According to an example, if executed by the control device, the at least one instruction may cause the vehicle control apparatus to identify a first group of storage devices, of each of which the storage capacity is greater than the first size of the first section, from among the plurality of storage devices, and to identify a storage device, of which the access cycle is smallest and which is expected if the first section is assigned, from among the first group of storage devices as the first minimum cost device.

According to an example, if executed by the control device, the at least one instruction may cause the vehicle control apparatus to identify a minimum cost device for a second section based on a second size of the second section corresponding to a second rank among the plurality of sections, and the storage capacity and the access cycle of each of the plurality of storage devices, to compare a sum of the first size and the second size with a first storage capacity of the first minimum cost device if the identified minimum cost device is the same as the first minimum cost device, and to assign the second section to the first minimum cost device if the comparison result indicates the sum of the first size and the second size is smaller than the first storage capacity.

According to an example, if executed by the control device, the at least one instruction may cause the vehicle control apparatus to identify a minimum cost device for a second section based on a second size of the second section corresponding to a second rank among the plurality of sections, and the storage capacity and the access cycle of each of the plurality of storage devices, to compare a sum of the first size and the second size with a first storage capacity of the first minimum cost device if the identified minimum cost device is the same as the first minimum cost device, and to exclude the first minimum cost device among the plurality of storage devices and to assign the second section to a second minimum cost device, of which the access cycle is smallest, if the identified minimum cost device is greater than the first minimum cost device.

According to an example, the vehicle control apparatus may further include a communication device. For example, if executed by the control device, the at least one instruction may cause the vehicle control apparatus to receive, based on the communication device, additional profiling data regarding the plurality of sections from an outside, and to determine a priority for each of the plurality of sections based on the additional profiling data.

According to an example of the present disclosure, a vehicle control method may include generating, by a control device, profiling data including an access count of each of a plurality of sections included in at least one task, determining, by the control device, a priority for each of the plurality of sections based on the profiling data, and sequentially assigning, by the control device, the plurality of sections to some of a plurality of storage devices included in a memory based on the priority.

According to an example, the vehicle control method may further include determining, by the control device, the priority for each of the plurality of sections based on a level of the access count.

According to an example, the vehicle control method may further include creating, by the control device, a table including the priority based on the profiling data, and determining, by the control device, a section for traversal among the plurality of sections based on the table.

According to an example, the vehicle control method may further include identifying, by the control device, a first minimum cost device for a first section among the plurality of storage devices based on a first size of the first section corresponding to a first rank among the plurality of sections, and a storage capacity and an access cycle of each of the plurality of storage devices, and assigning, by the control device, the first section to the first minimum cost device.

According to an example, the vehicle control method may further include identifying, by the control device, a first group of storage devices, of each of which the storage capacity is greater than the first size of the first section, from among the plurality of storage devices, and identifying, by the control device, a storage device, of which the access cycle is smallest and which is expected if the first section is assigned, from among the first group of storage devices as the first minimum cost device.

According to an example, the vehicle control method may further include identifying, by the control device, a minimum cost device for a second section based on a second size of the second section corresponding to a second rank among the plurality of sections, and the storage capacity and the access cycle of each of the plurality of storage devices, comparing, by the control device, a sum of the first size and the second size with a first storage capacity of the first minimum cost device if the identified minimum cost device is the same as the first minimum cost device, and assigning, by the control device, the second section to the first minimum cost device if the comparison result indicates the sum of the first size and the second size is smaller than the first storage capacity.

According to an example, the vehicle control method may further include identifying, by the control device, a minimum cost device for a second section based on a second size of the second section corresponding to a second rank among the plurality of sections, and the storage capacity and the access cycle of each of the plurality of storage devices, comparing, by the control device, a sum of the first size and the second size with a first storage capacity of the first minimum cost device if the identified minimum cost device is the same as the first minimum cost device, and excluding, by the control device, the first minimum cost device among the plurality of storage devices and assigning the second section to a second minimum cost device, of which the access cycle is smallest, if the identified minimum cost device is greater than the first minimum cost device.

According to an example of the present disclosure, a computer-readable recording medium including a program for executing a vehicle control method including generating, by a control device, profiling data including an access count of each of a plurality of sections included in at least one task, determining, by the control device, a priority for each of the plurality of sections based on the profiling data, and sequentially assigning, by the control device, the plurality of sections to some of a plurality of storage devices included in a memory based on the priority.

According to an example, the vehicle control method may further include determining, by the control device, the priority for each of the plurality of sections based on a level of the access count.

According to an example, the vehicle control method may further include creating, by the control device, a table including the priority based on the profiling data, and determining, by the control device, a section for traversal among the plurality of sections based on the table.

According to an example, the vehicle control method may further include identifying, by the control device, a first minimum cost device for a first section among the plurality of storage devices based on a first size of the first section corresponding to a first rank among the plurality of sections, and a storage capacity and an access cycle of each of the plurality of storage devices, and assigning, by the control device, the first section to the first minimum cost device.

According to an example, the vehicle control method may further include identifying, by the control device, a first group of storage devices, of each of which the storage capacity is greater than the first size of the first section, from among the plurality of storage devices, and identifying, by the control device, a storage device, of which the access cycle is smallest and which is expected if the first section is assigned, from among the first group of storage devices as the first minimum cost device.

The above description is merely an example of the technical idea of the present disclosure, and various modifications and modifications may be made by one skilled in the art without departing from the essential characteristic of the present disclosure.

Accordingly, examples of the present disclosure are intended not to limit but to explain the technical idea of the present disclosure, and the scope and spirit of the present disclosure is not limited by the above examples. The scope of protection of the present disclosure should be construed by the attached claims, and all equivalents thereof should be construed as being included within the scope of the present disclosure.

Descriptions of a vehicle control apparatus according to an example of the present disclosure, and a method therefor are as follows.

According to various examples of the present disclosure, a vehicle control apparatus may generate profiling data for each of sections included in a task, may determine a priority based on profiling data including an access count, may sequentially assign sections to a storage device starting from a section with a high priority, and may perform stable and highly accurate memory mapping operations.

According to various examples of the present disclosure, a vehicle control apparatus may assign a high priority to a section with a great access count, and may determine a minimum cost device, to which a section is assigned, based on the size of a section with a high priority, the storage capacity of a storage device, and an access cycle required or applied if the section is assigned.

According to various examples of the present disclosure, a vehicle control apparatus may compare the sum of sizes of a plurality of sections with the storage capacity of the minimum cost device, and may determine whether to assign the plurality of sections to one minimum cost device based on the comparison result, if it is identified that the plurality of sections need to be assigned to the one minimum cost device.

According to various examples of the present disclosure, a vehicle control apparatus may determine, based on further using additional profiling data received from an external source (e.g., an external library), a priority, may perform assignment operations for each of the sections, and may derive memory mapping results more adaptively and efficiently.

According to various examples of the present disclosure, a vehicle control apparatus may perform a memory mapping operation with higher accuracy and more efficiency compared to a memory mapping operation performed by a compiler, and may generate universally usable results while minimizing man-hours, because a developer does not need to directly intervene.

Besides, a variety of effects directly or indirectly understood through the present disclosure may be provided.

Hereinabove, although the present disclosure was described with reference to exemplary examples and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. An apparatus for controlling a vehicle, the apparatus comprising:
a memory configured to store at least one instruction; and
a control device operatively connected to the memory,
wherein the at least one instruction, when executed by the control device, cause the apparatus to:
generate profiling data comprising an access count of each of a plurality of sections, wherein the plurality of sections are associated with at least one task performed for an operation control of the vehicle;
determine, based on the profiling data, a priority for each of the plurality of sections;
sequentially assign, based on the priority, the plurality of sections to one or more of a plurality of storage devices included in the memory; and
output, based on the sequentially assigned plurality of sections, a signal for the operation control of the vehicle.

2. The apparatus of claim 1, wherein the at least one instruction, when executed by the control device, cause the apparatus to:
determine, based on a level of the access count, the priority for each of the plurality of sections.

3. The apparatus of claim 1, wherein the at least one instruction, when executed by the control device, cause the apparatus to:
generate, based on the profiling data, a table comprising the priority; and
determine, based on the table, a section for traversal among the plurality of sections.

4. The apparatus of claim 1, wherein the at least one instruction, when executed by the control device, cause the apparatus to:
determine, based on a first size of a first section of the plurality of sections, a first minimum cost device among the plurality of storage devices for the first section, wherein the first size corresponds to a first rank among the plurality of sections; and
assign the first section to the first minimum cost device.

5. The apparatus of claim 4, wherein the at least one instruction, when executed by the control device, cause the apparatus to:
determine first group of storage devices of the plurality of storage devices, wherein each storage device of the first group has a storage capacity that is greater than the first size; and
determine a storage device, of the first group of storage devices, as the first minimum cost device, wherein an access cycle of the storage device is smallest among the first group of storage devices.

6. The apparatus of claim 4, wherein the at least one instruction, when executed by the control device, cause the apparatus to:
determine, based on a second size of a second section of the plurality of sections, a second minimum cost device among the plurality of storage devices for the second section, wherein the second size corresponds to a second rank among the plurality of sections;
compare, based on a value associated with the second minimum cost device being the same as a value associated with the first minimum cost device, a sum of the first size and the second size with a first storage capacity of the first minimum cost device; and
assign, based on the sum being smaller than the first storage capacity, the second section to the first minimum cost device.

7. The apparatus of claim 4, wherein the at least one instruction, when executed by the control device, cause the apparatus to:
determine, based on a second size of a second section of the plurality of sections, a second minimum cost device for the second section, wherein the second size corresponds to a second rank among the plurality of sections;
compare, based on a value associated with the second minimum cost device being the same as a value associated with the first minimum cost device, a sum of the first size and the second size with a first storage capacity of the first minimum cost device; and
exclude, based on a value associated with the second minimum cost device being greater as a value associated with the first minimum cost device, the first minimum cost device from the plurality of storage devices and assign the second section to the second minimum cost device.

8. The apparatus of claim 1, further comprising:
a communication device,
wherein the at least one instruction, when executed by the control device, cause the apparatus to:
receive, based on the communication device and from an outside of the apparatus, additional profiling data regarding the plurality of sections; and
determine, based on the additional profiling data, a priority for each of the plurality of sections.

9. A method for controlling a vehicle, the method comprising:
generating, by a control device, profiling data comprising an access count of each of a plurality of sections, wherein the plurality of sections are associated with at least one task performed for an operation control of the vehicle;
determining, based on the profiling data, a priority for each of the plurality of sections;
the sequentially assigning, based on the priority, plurality of sections to one or more of a plurality of storage devices included in a memory; and
outputting, based on the sequentially assigned plurality of sections, a signal for the operation control of the vehicle.

10. The method of claim 9, further comprising:
determining, based on a level of the access count, the priority for each of the plurality of sections.

11. The method of claim 9, further comprising:
generating, based on the profiling data, a table comprising the priority; and
determining, based on the table, a section for traversal among the plurality of sections.

12. The method of claim 9, further comprising:
determining, based on a first size of a first section of the plurality of sections, a first minimum cost device among the plurality of storage devices for the first section, wherein the first size corresponds to a first rank among the plurality of sections; and
assigning the first section to the first minimum cost device.

13. The method of claim 12, further comprising:
determining a first group of storage devices of the plurality of storage devices, wherein each storage device of the first group has a storage capacity that is greater than the first size; and
determining a storage device, of the first group of storage devices, as the first minimum cost device, wherein an access cycle of the storage device is smallest among the first group of storage devices.

14. The method of claim 12, further comprising:
determining, based on a second size of a second section of the plurality of sections, a second minimum cost device among the plurality of storage devices for the second section, wherein the second size corresponds to a second rank among the plurality of sections;
comparing, based on a value associated with the second minimum cost device being the same as a value associated with the first minimum cost device, a sum of the first size and the second size with a first storage capacity of the first minimum cost device; and
assigning, based on the sum being smaller than the first storage capacity, the second section to the first minimum cost device.

15. The method of claim 12, further comprising:
determining, based on a second size of a second section of the plurality of sections, a second minimum cost device for the second section, wherein the second size corresponds to a second rank among the plurality of sections; and
comparing, based on a value associated with the second minimum cost device being the same as a value associated with the first minimum cost device, a sum of the first size and the second size with a first storage capacity of the first minimum cost device or excluding, based on a value associated with the second minimum cost device being greater as a value associated with the first minimum cost device, the first minimum cost device from the plurality of storage devices and assigning the second section to the second minimum cost device.

16. A non-transitory computer-readable recording medium including a program for executing the method comprising:
generating, by a control device, profiling data comprising an access count of each of a plurality of sections, wherein the plurality of sections are associated at least one task performed for an operation control of a vehicle;
determining, based on the profiling data, a priority for each of the plurality of sections;
sequentially assigning, based on the priority, the plurality of sections to one or more of a plurality of storage devices included in a memory; and
outputting, based on the sequentially assigned plurality of sections, a signal for the operation control of the vehicle.

17. The non-transitory computer-readable recording medium of claim 16, wherein the method further comprises:
determining, based on a level of the access count, the priority for each of the plurality of sections.

18. The non-transitory computer-readable recording medium of claim 16, wherein the method further comprises:
generating, based on profiling data, a table comprising the priority; and
determining, based on the table, a section for traversal among the plurality of sections.

19. The non-transitory computer-readable recording medium of claim 16, wherein the method further comprises:
determining, based on a first size of a first section of the plurality of sections, a first minimum cost device among the plurality of storage devices for the first section, wherein the first size corresponds to a first rank among the plurality of sections; and
assigning the first section to the first minimum cost device.

20. The non-transitory computer-readable recording medium of claim 19, wherein the method further comprises:
determining a first group of storage devices of the plurality of storage devices, wherein each storage device of the first group has a storage capacity that is greater than the first size; and
determining a storage device, of the first group of storage devices, as the first minimum cost device, wherein an access cycle of the storage device is smallest among the first group of storage devices.
